(19) United States
(12) Patent Application Publication
(10) Pub. No.: US 2024/0232584 A1
(43) Pub. Date: Jul. 11, 2024

(54) Event Based Analysis and Saliency Detection and Classification of Signals

(71) Applicant: Raytheon BBN Technologies Corp., Cambridge, MA (US)

(72) Inventor: Scott Ritter, Sudbury, MA (US)

(21) Appl. No.: 18/299,679

(22) Filed: Apr. 12, 2023

Related U.S. Application Data
(60) Provisional application No. 63/438,227, filed on Jan. 10, 2023.

(51) Int. Cl. G06N 3/0464; G06N 3/049

(52) U.S. Cl. CPC G06N 3/0464; G06N 3/049

(57) ABSTRACT

An event-based signal saliency detection and classification system operable to receive an input signal and convert the input signal to input data. The system transforms input data from the temporal domain into the frequency domain in a plurality of frequency domain bins. Each of the frequency domain bins are monitored for magnitude changes that meet or exceed a threshold value. Event data corresponding to an event at which time a magnitude change meets or exceeds the threshold value is detected in the frequency domain bins can be stored in an event plane. The system can output the event data a saliency-classifier convolutional neural network (CNN) to classify the event data as salient data or non-salient data and output the salient data for processing by a downstream processor to produce analysis output data.

### RELATED APPLICATIONS

This application claims the benefit of U.S. Provisional Application Serial No. 63/438,227, filed Jan. 10, 2023, and entitled, “Event-based System and Method for Saliency Detection and Classification,” which is incorporated by reference in its entirety.

### BACKGROUND

Analysis, detection, and characterization of various types of signals (such as radio or sound wave signals) that vary in frequency content and/or magnitude over time are important in various fields in order to better understand signals and to produce devices and systems that rely on these signals for operation. Such signals include sound waves, vibrations, electromagnetic radiation such as RF waves, wavelets, and others. In analyzing and processing these signals, a broadband signal that encompasses an entire respective propagation domain may be received and analyzed by a computer or processor over time. However, much of the total signal content may represent information that is of no interest to the analysis. Accordingly, response times and operating efficiencies of a computer, processor, or software program are negatively affected by such computing resources being used to analyze portions of the signal that have little to no useful information. Therefore, more efficient processing methods and computer systems are desirable to conserve energy, enhance processing speed, and more efficiently utilize available computing resources when analyzing signals within broadband signal domains.

### SUMMARY

An initial summary of the disclosed technology is provided here. Specific technology examples are described in further detail below. This initial summary is intended to set forth examples and aid readers in understanding the technology more quickly but is not intended to identify key features or essential features of the technology nor is it intended to limit the scope of the claimed subject matter.

In one example of the present disclosure, an event-based signal detection and classification system can include a signal converter operable with an input, and operable to receive and convert one or more input signals, at least one processor, and a memory device. The memory device can include instructions that, when executed by the at least one processor, cause the system to receive, via the input, an input signal of the one or more input signals. The system can further convert the input signal to input data and input the input data to an event-based saliency detection and classification component. The event-based detection and classification component can transform, periodically, the input data from the temporal domain into the frequency domain in a plurality of frequency domain bins. The event-based detection and classification component instance can further monitor each of the frequency domain bins for magnitude changes that meet or exceed a predetermined threshold value. The system can further detect an event when a magnitude change meeting or exceeding a predetermined threshold value occurs. The system can further generate event data for the event, wherein the event data corresponds to a point in time at which a magnitude change that meets or exceeds the predetermined threshold value is detected in one of the frequency domain bins, and output the event data of the one or more events for further processing to produce analysis output data. For example, the system can output the event data to a saliency-classifier CNN to classify the event data as salient data or non-salient data. The salient data can be output for processing by a downstream processor to produce analysis output data.

According to another example, the instructions embodied on the memory device can exhibit a computer implemented method for processing one or more input signals. According to another example, the instructions can be stored on a non-transitory machine-readable storage medium for execution by a processor.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a diagram illustrating a system for Event-Based Saliency Detection and Classification (SDC) of signals according to at least one example of the present disclosure.

FIG. 2 is a diagram illustrating an example of an Event-Based SDC component from the system of FIG. 1.

FIG. 3 is a diagram illustrating another system for Event-Based SDC of signals according to at least one example of the disclosure.

FIG. 4 is a block diagram illustrating an example of a computing device that may be used to implement the technology disclosed herein in accordance with an example of the present disclosure.

FIG. 5 is a flow diagram illustrating an example method for Event-Based SDC of signals according to at least one example of the disclosure.

FIG. 6A is a flow diagram illustrating an example process for monitoring frequency domain bins for magnitude changes that meet or exceed a threshold value.

FIG. 6B is a flow diagram illustrating an example process for monitoring frequency domain bins for magnitude changes that meet or exceed a threshold value.

Reference will now be made to the exemplary embodiments illustrated, and specific language will be used herein to describe the same. It will nevertheless be understood that no limitation of the scope of the invention is thereby intended.

### DETAILED DESCRIPTION

In describing and claiming the present disclosure, the following terminology will be used in accordance with the definitions set forth below.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

Before exemplary embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of devices, methods, systems, elements thereof, etc., to provide a thorough understanding of various exemplary embodiments. One skilled in the relevant art will recognize, however, that such detailed embodiments do not limit the overall inventive concepts articulated herein but are merely representative thereof.

Technologies are described herein for the analysis and processing of signals, such as wave signals, by a computer system including at least one processor and at least one memory storing instructions for processing the wave signals executed by the processor. The “signals” processed by the systems, devices, and methods described herein are not intended to be particularly limited by this disclosure. The “signals” can refer to any signal (e.g., input signal) that can include, but is not intended to be limited to, one-dimensional signals (e.g., a signal that can be represented by function f(t)=x, where t is time), RF signals, sound waves, electromagnetic radiation, electrical signals, wavelet signals, and multi-dimensional signals in both the frequency and wavelet domains. Additionally, “signals” can include signals that are one-dimensional but exhibit a higher dimensionality due to multiple components, such as quadrature (i.e., sine and cosine components of the signal) being present in the radio or other wave signals.

The technologies described herein are directed to a system for event-based analysis and/or classification of input signals, such as radio signals. The systems and methods described herein employ an event-based approach to selecting relevant input data from an input signal for further processing and analysis, transforming the selected input data using a mathematical transform algorithm, and detecting events in the transformed input data based on which pieces of transformed input data meet an event-based criterion for triggering an event. Transformed input data triggering an event based on the event-based criterion can be further processed and analyzed by systems configured to perform further signal feature extraction, signal classification, and/or Saliency Detection and Classification (SDC) of event data based on the transformed input data triggering an event. The event-based systems and methods can be used together with image-based Convolutional Neural Network (CNN) signal processing techniques to extract features from the event data, to classify the event data, and/or classify event data as salient and non-salient data in an input signal.

In the event-based analysis or classification of input data from an input signal, the transformed input data can be classified as either triggering an event or not triggering an event based on the transformed input data either satisfying or not satisfying an event-based criterion. As used herein, “event-based criterion” can refer to a threshold value for a measurable characteristic (e.g., frequency, amplitude, magnitude change, etc.) of transformed input data representing an input signal that, when met or exceeded, triggers detection of an event in the transformed input data. The event-based criterion that triggers an event can be defined by a user who programs a system or a device with instructions on what characteristics to look for in the transformed input data based on the input signal, with the event-based criterion being based on one or more selected characteristics from the transformed input data based on the input signal. Such characteristics can include a magnitude, a frequency, a change in magnitude, a change in frequency, or any other properties or characteristics of the input signal in which a user is interested. Alternatively, the event-based criterion and whether the transformed input data triggers detection of an event can be defined by artificial intelligence or processing algorithms embedded in the memory and processor of a computer analyzing the input signal.

Following event-based analysis of the transformed input data from the input signal, the resulting event data can be further output to a CNN for signal feature extraction, signal classification, and/or Saliency Detection and Classification (SDC) of the data from the event-triggering input signal as salient or non-salient.

As a result of the event-based analysis of the transformed input data based on the input signal, only specific or particular transformed input data (e.g., event data) that satisfy an event-based criterion are output for further processing rather than all input data from the input signal. Therefore, computer processing and memory resources can be conserved and used more efficiently when compared with prior systems that operate to process all or some of the data of an input signal without event-based classification. In other words, computers and processors running analysis and processing on input signals (such as saliency detection, signal feature extraction, and/or signal classification) can operate faster by not having to process data that is nor relevant or not of interest (i.e., does not satisfy event-based criterion to trigger an event) to a user or algorithm. Accordingly, the technologies described herein can provide significant advantages over prior technologies, such as increase signal processing speeds, increase signal processing efficiency, decrease latency in computers and processors processing and analyzing input signals, and reduce costs associated with signal processing. Still other advantages can include 1) the reduction in intra-component data transfer resources yielded by transferring only event data to a CNN or downstream processor, and 2) the computational hardware reduction of operating a CNN or downstream processor on input event data whose hardware representation need only indicate the absence or presence of an event along with the sign of the magnitude change that produced the event, rather than operating on a numerical value requiring a more complex representation.

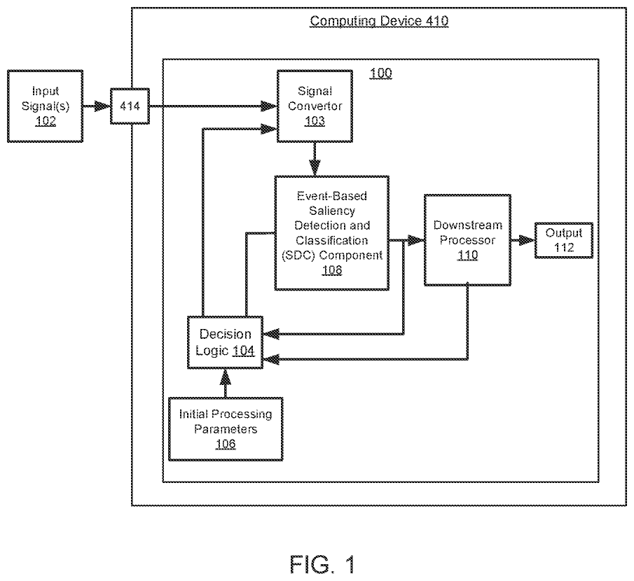

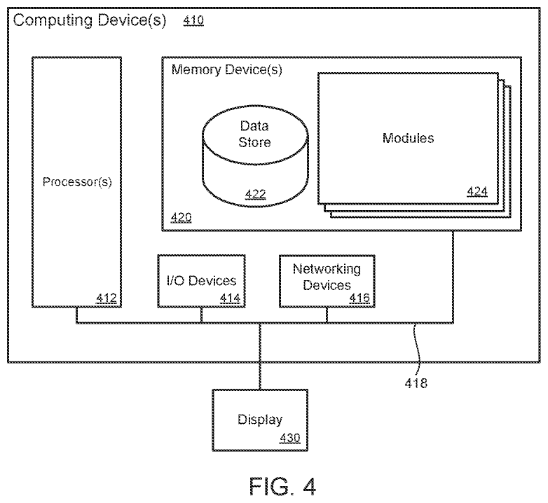

To describe the present technology, examples are now provided with reference to the figures. With reference to FIG. 1 an event-based signal classification system 100, such as for event-based Saliency Detection and Classification (SDC) of signals, signal feature extraction, and/or signal classification, with the following discussion focusing on event-based Saliency Detection and Classification (SDC) as an example. The system 100 can be operable with a computing system (e.g., computing device 410 in FIG. 4) including any needed hardware components, and including at least one processor and at least one memory device that stores instructions executed by the at least one processor to carry out the functions and operations of the elements and components (i.e., elements 104-112) of the system 100 illustrated in FIG. 1. As shown in FIG. 1, an input signal 102 (e.g., RF signals) can be input into the system 100.

The input signal 102 can be any type of wave-based signals, such as temporal signals, spectrotemporal signals, temporal wavelet signals, electromagnetic waves/radiation, sound waves, multi-dimensional waves, and or other frequency or wave-based signals as will be apparent to those skilled in the art without any intended limitation. The input signal 102 can include one or more frequencies or frequency bands. For purposes of simplicity and illustration the discussion with respect to the figures will focus on and identify wide-band radio frequency (RF) waves as the example input signal 102. The RF waves as the input signal 102 can originate from any source without any intended limitation.

The input signal 102 can be input into the system 100 via any signal input port operable to interface with a computer of computing device (e.g., a processor and a memory, such as the computing device 414 (see also computing device 414 of FIG. 4)) configured to analyze, display, or store signals. For example, the signal input port can be a wire port, cable port, antenna, receiver, or any other type of input capable of receiving and conveying the input signal 102 without any intended limitation. With respect to the computing device 410 (see also FIG. 4), the signal input port can comprise an input port 414 (which can be one of the input devices 414 shown in FIG. 4). The input signal 102 can first be input to a signal converter 103 that converts the input signal to input data that is readable by a computer, such as the computing device 410. As used herein, the term “data,” is intended to refer both data in the plural and datum in the singular. Whether data is singular or plural can depend on the input signal 102 being input into the system 100. The signal converter 103 can convert certain frequencies or frequency bands of the input signal to input data based on a band selection parameter defined by initial processing parameters 106 and/or decision logic 104. After converting the input signal 102 to input data by the signal converter 103, the input data from the signal converter 103 can be input to an event-based saliency detection and classification (SDC) component 108. The input data from the input signal 102 can then be processed in accordance with the decision logic 104 programmed into the system 100. The decision logic 104 can include one or more initial processing parameters 106, such as event-based criterion, that can define features of interest when processing the input data based on the input signal 102 and dictate how the input data are processed by the system 100. A user can define the initial processing parameters 106 through a user input to the system 100 via a user interface (e.g., one of the input devices 414 shown in FIG. 4). Alternatively, or additionally, the initial processing parameters can be preset to default values or automatically detected by the system 100 based on the type, frequency, or amplitude of the input signal 102, or based on other characteristics of interest initially stored in and/or detected by the system 100.

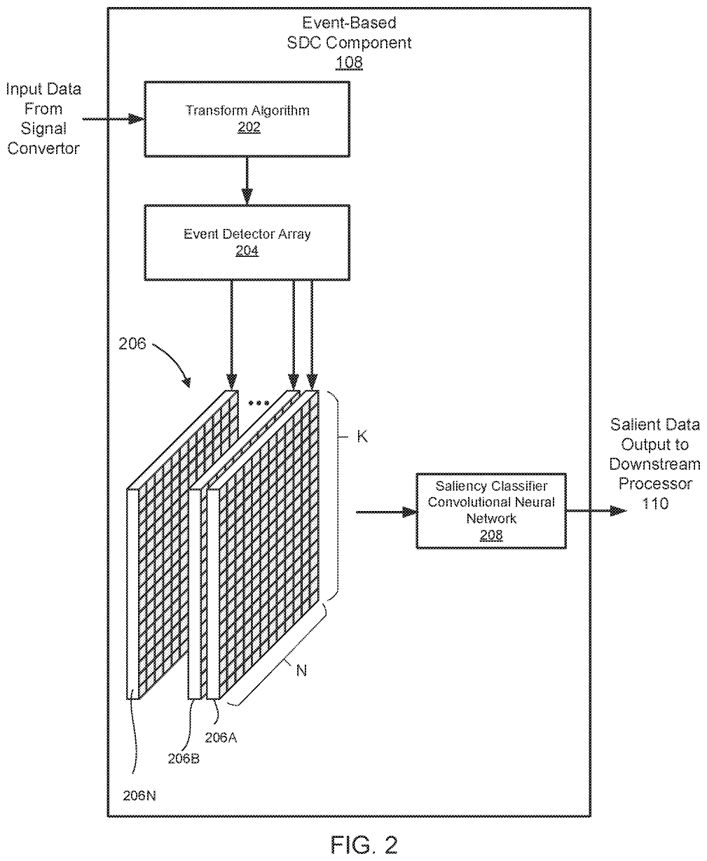

The event-based SDC component 108 operates to analyze samples of the input data based on the input signal 102 over time at a specified temporal resolution. The “temporal resolution” defines a predetermined time interval used for sampling a plurality of instances of data of the input signal 102. The temporal resolution can be established by the decision logic 104 based on the initial processing parameters 106 that are preset, detected, or input by a user. The temporal resolution can be controlled by the decision logic 104 and communicated to the event-based SDC component 108. The input data can be transformed using a mathematical transform algorithm (e.g., transform algorithm 202 shown in FIG. 2) and can then be analyzed for particular events representing magnitude changes in the transformed input data at certain points of time that meet or exceed a predetermined threshold value.

Any change in magnitude of the transformed input data (e.g., magnitude change in the frequency components, such as FFT bins, wavelet, or other transform component) of the input signal that meets or exceeds a predetermined threshold value is detected by an event detector array as an “event.” An event can be represented by “event data” comprising information indicative of the event (i.e., the change in magnitude of the transformed input data) at a certain point in time, which event data can be stored. Multiple events can be represented by “event data,” which can comprise information indicative of the multiple events at a plurality of respective points in time, which event data can be stored. The event data of the detected events can comprise any number of discrete packets of information. Each packet of information can comprise the event data of a respective event, which event data can comprise information in the form of a bit of information representative of the event, or in other words, the magnitude change of the transformed input data that meets or exceeds the threshold value, which event occurs at a given time. In one example, the event data from a plurality of events can comprise a plurality of discrete bits of information, each bit of information representing a respective event, and each comprising one of a sign (+/−) or a number expressed in the base-2 numeral system (i.e., binary number system). As a specific example, the event data of a detected event can comprise a bit of information in the form of a “+” sign representative of a positive magnitude change indicating an increase in magnitude change of the transformed input data. Similarly, the event data of a detected event can comprise a bit of information in the form of a “−” sign representative of a negative magnitude change indicating a decrease in magnitude change of the transformed input data. In another example, the event data of a detected event can comprise a bit of information in the form of a number in the base-2 numeral system or binary number system, such as a “1” that is representative of a positive magnitude change event, or a “0” that is representative of a negative magnitude change event. In still another example, the event data of a detected event can comprise a bit of information in the form of a “+” sign representative of a positive magnitude change, or a “−” sign representative of a negative magnitude change, each of which can be stored along with additional bits of information, such as a “1” or a “0” representative of an absence of an event, or in other words an absence of a magnitude change of the transformed input data that meets or exceeds the threshold value. The event data can then be classified as salient or non-salient by a Saliency Classifier algorithm or device, to indicate, for example, the presence of corresponding salient information within the original 102 input signal. Still other examples are contemplated, some of which are described below.

A detailed description of the operation of the event-based SDC component 108 is given here with reference to FIG. 2 of the drawings. FIG. 2 is a diagram illustrating a detailed example of the event-based SDC component 108 from the system of FIG. 1. With reference to FIGS. 1 and 2, the input data based on the input signal 102 from the signal converter 103 can be input to the event-based SDC component 108. The input data from the signal converter 103 can first be in a spatiotemporal domain or a temporal domain expressing quantities of magnitude over time. The input data input to the event-based SDC component 108 can be transformed, for example, from the temporal domain/spatiotemporal domain to a frequency domain/spectrotemporal domain expressing frequency component magnitudes of the input signal. The input data can be transformed into the frequency domain or spectrotemporal domain by a mathematical transform algorithm used to map a function from an original domain to a different domain by integration. For example, a Fourier transform algorithm can be used to decompose functions into frequency components represented by the output of the transform as a function of frequency. Within the event-based SDC component 108, the input data can be transformed using a Fourier transform algorithm to transform the input data from the temporal domain to the frequency domain. As shown in FIG. 2, a processor can process the input data with a transform algorithm 202 that converts the input data to the frequency domain by decomposing a sequence of values (i.e., a sequence of values of input data converted from the input signal by the signal converter 103) into components of different frequencies. The transform algorithm can be a fast Fourier transform (FFT) algorithm. However, it is to be understood that any transform algorithm without any intended limitation can be used as the transform algorithm 202. For example, any Fourier transform, such as a discrete Fourier transform algorithm, a non-uniform discrete Fourier transform (NUDFT) can be alternatively used in place of the FFT algorithm. Any other transform algorithms, for example a wavelet transform, can be used without any intended limitation. For purposes of illustration and example, the algorithm 202 discussed below will be an FFT algorithm 202. The FFT algorithm 202 can transform and discretize input data into N number of frequency domain bins (“N” representing any number).

The number N of frequency domain bins can be based on the temporal resolution defined in the initial processing parameters 106. As such, like the initial processing parameters 106, the number N of frequency domain bins that result from the FFT algorithm 202 can be selected by the user or can be designated as a default value by the decision logic 104. Additionally, the system 100 can detect a proper N number of frequency domain bins to be created by the FFT algorithm 202 based on the length of the input signal, number of frequencies in the input signal, or other characteristics of the input signal.

The FFT algorithm 202 can further be designated, whether by the user, stored default values, or detection by the algorithm, to run for a predetermined analysis interval, which analysis interval can be one of the initial processing parameters 106. The “analysis interval” can define a rate at which the input data from the converted input signal are processed and analyzed by the event-based SDC component 108. For each analysis interval, the input data is transformed by the FFT algorithm 202. Additionally, for each analysis interval, the transformed input data is processed by the event detector array 204 to determine the existence of events in the transformed input data. Furthermore, for each analysis interval, the event detector array 204 generates event data representative of one or more events detected in the transformed input data over the analysis interval. Additionally, for each analysis interval, the event data is output to and stored in the event plane 206. After the event data is stored, the event data is output to the CNN 208 for further processing and analysis during each analysis interval. This is discussed in more detail below.

In an example, if the analysis interval is defined as 1 second, then the input data will be transformed by the FFT every 1 second. For illustrative purposes, an FFT algorithm 202 that operates for one second of input data, having a sample rate (e.g., temporal resolution) of 100 Hz and a size of 100 (e.g., the number of frequency domain bins N equals 100) would divide a range of frequencies from 0 to 100 Hz into 100 intervals. Therefore, in the example analyzed over a 1 second analysis interval, each frequency domain bin would cover an interval of 1 Hz (i.e., the frequency domain bins would be 0 to 1 Hz as one bin, 1 to 2 Hz as another bin, 2 to 3 Hz as another bin, and so on). The analysis interval can be set in a similar manner as the other initial processing parameters 106 (e.g., number of bins N, temporal resolution, band selection).

The event-based SDC component 108 can compute a single FFT analysis of the input data. Alternatively, for purposes of event detection in the transformed input data, the event-based SDC component 108 can compute a plurality of FFT analyses for the input data. The FFT analyses can be successive one after another. In other words, a first FFT analysis can be run on the input data for an interval from 0 to 1 seconds and a second FFT analysis can be run for an interval from 1 to 2 seconds after the first FFT is complete. FFT analyses can be run in an overlapping manner as well. For example, a first FFT analysis can be run for an interval from 0 to 1 seconds and a second FFT analysis can be run at least partially overlapping with the first FFT analysis for an interval from 0.1 seconds to 1.1 seconds. Successive FFT analyses can also be run for decimated intervals as well. For example, a first FFT analysis can be run for an interval from 0 to 1 seconds and a second FFT analysis can be run for an interval separated from the interval of the first FFT analysis such as an interval from 1.5 seconds to 2.5 seconds.

With further reference to FIG. 2, after transformation of the input data by the FFT algorithm 202 into the frequency domain bins, the frequency domain bins can be monitored by an event detector array 204 which monitors each of the N frequency domain bins for magnitude changes. Each of the frequency domain bins contain magnitude data of the transformed input data at certain points in time over a range of frequencies defined by the size of the frequency bin. The event detector array 204 monitors the magnitude of the transformed input data in each of the frequency domain bins and looks for changes in magnitude in the transformed input data within each individual frequency domain bin. As indicated above, any change in magnitude of the transformed input data within a frequency domain bin that meets or exceeds a predetermined threshold value is detected by the event detector array 204 as an “event” having associated event data. The predetermined threshold value can be stored as an initial processing parameter 106 and can define a magnitude change value that, when met or exceeded, triggers detection of an event in the transformed input data by the event detector array 204. The predetermined threshold value can be set by the user, can be set as an initial default value, or can be determined based on one or more characteristics of the input data, such as the magnitude or frequency statistics of the input data.

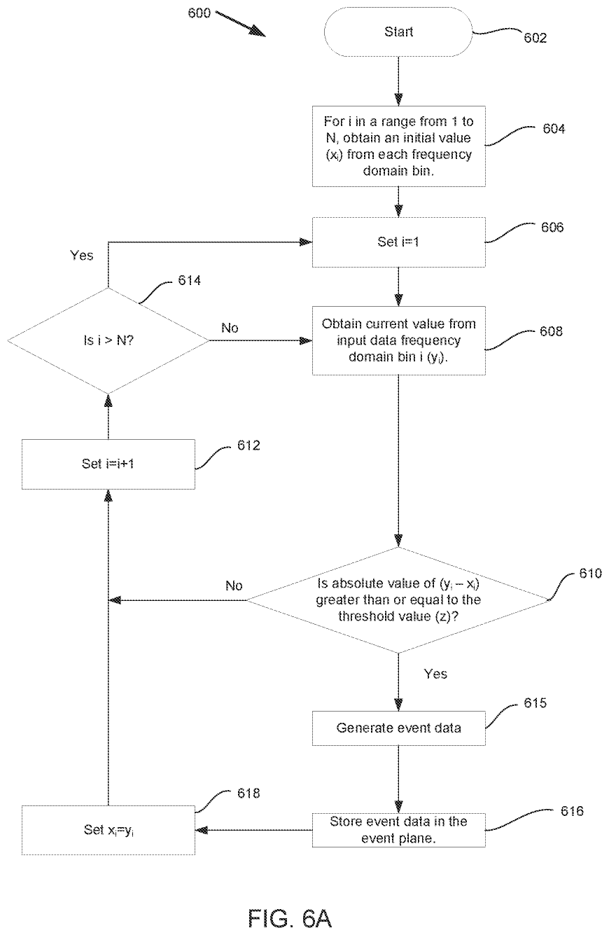

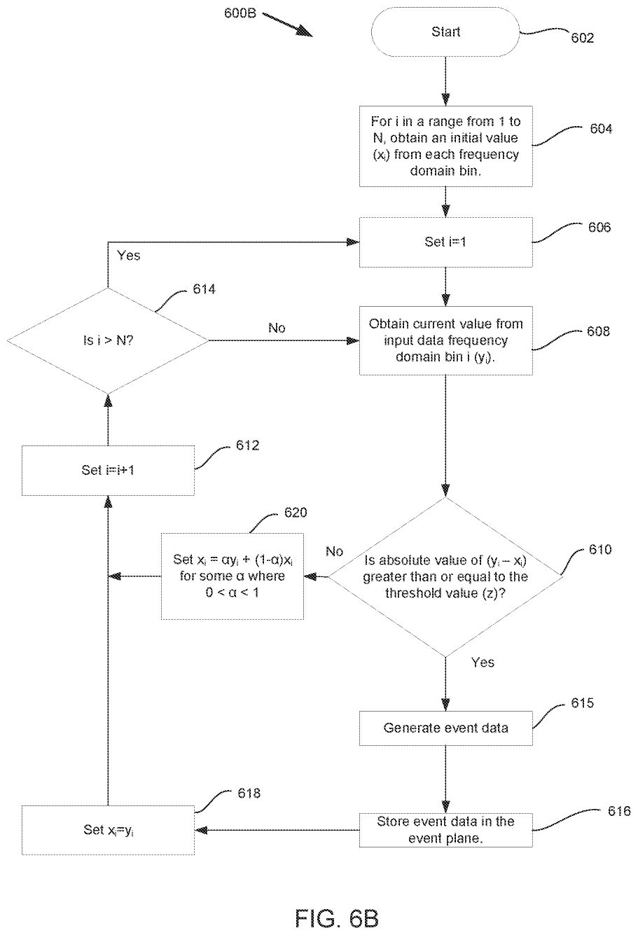

As an example, the event detector array 204 detects an “event” in the transformed input data. The system 100 and the event detector array 204 thereof can operate in accordance with the processes 600 and 600B illustrated in the flow diagrams of FIGS. 6A-6B, which are described in further detail below. The event detector array 204 detects an “event” in the transformed input data, in which the magnitude of the transformed input data changes by an amount meeting or exceeding the predetermined threshold value (z). As illustrated in FIGS. 1 and 2 in conjunction with FIGS. 6A and 6B, the event detector array 204 of the system 100 can detect an event by first detecting an initial magnitude (e.g., xᵢ as shown and described with respect to FIGS. 6A and 6B later) of the transformed input data in an initial frequency domain bin. The event detector array 204 then monitors the magnitude of the transformed input data in the initial frequency domain bin for a second magnitude (i.e., a magnitude different from the initial detected magnitude) in the initial frequency domain bin. The second magnitude can be a current magnitude (e.g., yᵢ as shown and described with respect to FIGS. 6A and 6B later) observed at a certain point in time subsequent to the time at which the initial magnitude (xᵢ) is observed. When event detector array 204 monitors a second magnitude (yᵢ) in the initial frequency domain bin representing a change in the magnitude of the transformed input data that meets or exceeds the predetermined threshold value (z) compared to the initial magnitude, the event detector array 204 detects the magnitude change as an event (i.e., initial event). For any detected event, the event detector array 204 can generate event data representative of the detected event. In one example, the event data can comprise information representative of a sign (e.g., a bit of information comprising a “+” sign or a “−” sign), of the magnitude change (i.e., a positive magnitude change for an increase in magnitude and a negative magnitude change for a decrease in magnitude.

Following detection of the initial event, the event detector array 204 can continue monitoring N number frequency domain bins (e.g., the initial frequency domain bin and/or other frequency domain bins different from the initial frequency domain bin). Following detection of the second magnitude (yᵢ), the event detector array 204 continues monitoring the initial frequency domain bin for a third magnitude (e.g., yᵢ₊₁, yᵢ₊₂, etc.) subsequent to the second magnitude (i.e., a magnitude different from the second magnitude yᵢ). When the third magnitude (e.g., yᵢ₊₁, yᵢ₊₂, etc.) represents a change in magnitude of the transformed input data that meets or exceeds the predetermined threshold value (z) compared to the second magnitude (yᵢ), the event detector array 204 detects the magnitude change as an event (i.e., a second event). The event detector array 204, in response to detecting the second event, can generate second event data representative of the detected second event. Following generation of the second event data for the second event, the second event data can be output to the spectrotemporal event plane 206 and stored therein. The event detector array 204 can then continue monitoring each of the N number frequency domain bins in similar fashion for changes in magnitude in the transformed input data meeting or exceeding a predetermined threshold value (z) compared to the magnitude (e.g., yᵢ, yᵢ₊₁, to y_{i+N}) observed at an immediately preceding event or observed as the initial magnitude (e.g., xᵢ).

Additionally or alternatively, the event detector array 204 can gradually vary the initial magnitude value (xᵢ) in order to track with minor movements or changes in the current magnitude value (yᵢ) of the transformed input data over time. Varying the initial magnitude value (xᵢ) over time can filter out small changes between the current magnitude value (yᵢ) of the transformed input data and the initial magnitude value (xᵢ). Such small changes by themselves may not exceed the threshold value (z), but over an amount of time can cause the current magnitude values (yᵢ through y_{i+N}) of the transformed input data to gradually drift away from the initial magnitude value (xᵢ). By these small changes to the transformed input data over time, a very small change in the current magnitude value (xᵢ) can cause the difference between one of the current magnitude values (yᵢ through y_{i+N}) of the transformed input data and the initial magnitude value (xᵢ) to exceed the threshold (z) and trigger an event, when, in fact, no change big enough to worth noting as an event occurred. For purposes of this disclosure, large changes in magnitude over short periods of time may signify a feature of interest in an input signal while smaller changes over longer periods of time may not signify any features of interest in the input signal. Accordingly, it can be advantageous to disregard small changes over long periods of time that may together trigger a magnitude change greater than or equal to the threshold value (z).

To prevent small gradual changes in magnitude from triggering an event (xᵢ) can be modified by to allow the initial value (xᵢ) to track along with minor changes in the current values (yᵢ). For example, the event detector array 204 can monitor each of the frequency domain bins for magnitude changes in the transformed input data (e.g., current magnitude value (yᵢ)) relative to an initial magnitude value (xᵢ) that are below the predetermined threshold value (z). In a case in which the magnitude change in the input data (yᵢ) relative to an initial magnitude value (xᵢ) does not exceed the threshold value (z), the initial magnitude value (xᵢ) can be updated to a new updated magnitude value that tracks magnitude changes in the transformed input data (yᵢ) that are below the predetermined threshold value (z).

An exemplary method for modifying the initial magnitude value (xᵢ) is discussed below in further detail with reference to FIGS. 6A and 6B. The initial magnitude value (xᵢ) can be modified to track along with minor changes to the transformed input data (yᵢ) over time.

Modifying (xᵢ) in this manner advantageously updates the initial magnitude value (xᵢ) to slowly track the current magnitude value (yᵢ) over time, so that small magnitude changes (i.e. magnitude changes occurring little by little over many analysis intervals) between the initial magnitude (xᵢ) and current magnitude (yᵢ) that do not meet or exceed the threshold (z) do not accumulate over time and produce undesired events. In subsequent iterations, the event detector array 204 can then search for magnitude changes in frequency domain bins based on the updated magnitude value instead of the initial magnitude value.

Following detection of any events as described in any of the examples above, the event detector array 204 can continue detecting events (e.g., first, second, third, fourth, fifth events etc.) and generating corresponding event data (e.g., first, second, third, fourth, fifth event data etc.) for each point in time at which the magnitude of the transformed input data within one of the frequency domain bins changes by an amount sufficient to meet or exceed the predetermined threshold value. The magnitude change can be either positive or negative to trigger detection of an event and generation of event data by the event detector array 204. The predetermined threshold value can be any value specified by either the user, an algorithm, or default stored values. The magnitude monitored can be an absolute magnitude change in the linear value of the magnitude of the transformed input data monitored in the frequency domain bins, or it can be an absolute magnitude change in a logarithm value of the magnitude of the transformed input data monitored in the frequency domain bins. While the magnitude change of a logarithm value can yield a broad dynamic range, any magnitude change difference compared to a predetermined threshold value can be useful depending on the intended function of the system 100 and/or the circumstances or desires of the user. In short, the predetermined threshold value can be defined in any way for the purposes of the user without any intended limitation.

Following generation of the event data from one or more events (e.g., first, second, third, fourth, fifth events, etc.), the event data (e.g., event data associated with the first, second, third, fourth, fifth events, etc.) can be output to and stored in a spectrotemporal event plane 206. The spectrotemporal event plane 206 can be a memory device or memory circuit that receives and stores the event data in accordance with software instructions executed by a processor. Alternatively, the spectrotemporal event plane 206 can be a software module (e.g., one or more of modules 424 of FIG. 4) that, when executed by a processor (e.g., processor 412), stores the event data within a data store (e.g., data store 422 of FIG. 4) of a computing device (e.g., computing device 410).

The event data generated by the event detector array 204 and stored in the spectrotemporal event plane 206 represents changes with respect to a one-dimensional variable (i.e., a magnitude change vector indicating a threshold change of magnitude in a frequency domain bin of the frequency domain bins of the FFT algorithm 202). The one dimensionality of the event data enables successive event data to be stored in “shift-registered” (e.g., first-in-first-out) fashion, thereby associating each packet of event data with a point in time. Accordingly, the spectrotemporal event plane 206 can be a two-dimensional plane (e.g., including dimensions of magnitude and time) for storing the event data input from the event detector array 204.

The spectrotemporal event plane 206 can comprise one or more planes or channels (i.e., first channel 206A through Nth Channel 206N in FIG. 2). Each of the one or more channels can comprise a number of rows K for storing successive packets or information of event data that arise from each output frequency domain bin of the transform 202 over each analysis interval. The number of rows K can be a configurable parameter corresponding to the duration over which the received signal is to be analyzed by the CNN 208 (i.e., the analysis window). The spectrotemporal event plane 206 can further comprise a number of columns N, where each column N corresponds to a frequency domain bin output from the transform algorithm 202. At any point during the operation of the system, a row occupied by any event data corresponds to a time (i.e., analysis interval of the transform algorithm 202) at which each event data in the row occurred. In other words, each of the rows (K) represent a particular point in time associated with any instances of event data stored therein.

After each analysis interval of the FFT algorithm 202, the frequency domain bins N of a current row (e.g., topmost row) of the grid (e.g., one or more of channels 206A-206N) of the spectrotemporal event plane 206 are populated with any new event data detected by the event detector array 204 based on the transformed input data from a current analysis interval of the FFT algorithm 202. In one implementation, prior to inserting the results of an analysis interval of the FFT algorithm 202 into the current row (e.g., topmost row) of the event plane 206, the contents of all of the older rows are shifted downward by one row and the contents of the oldest row (e.g., bottom row) are discarded. In the case in which no events occurred in a particular frequency domain bin N, such particular frequency domain bin N can be left empty in the current row (or assigned a pre-determined value indicative of the absence of an event). One advantage of the present technology is that timestamps do not need to be stored in the spectrotemporal event plane 206. This is because the event data associated with each time/analysis interval is initially stored in respective uppermost rows of the event plane 206 at an initial time, wherein time data associated with the initial time is output to the CNN 208 with the event data. Accordingly, the time associated with new event data is implicit based on the row of the grid in which the event data is stored. Therefore, individual timestamps of the event data need not be stored in the frequency bins of the grid. Furthermore, frequency data of the event data is implied based on the frequency domain bin (i.e., column N) in which the event data is stored. Therefore, the frequency data of the event data need not be stored in the spectrotemporal event plane 203.

In an initial example of the operation of the event-based SDC component 108, the spectrotemporal event plane 206 can include a single plane or channel (i.e., only first channel 206A with channels 206B and 206N being omitted). In the example where the event-based SDC component 108 comprises a single channel, the event data (e.g., data associated with an initial event, a second event, a third event, a fourth event, etc.) can comprise sign change data indicating the direction or sign (i.e., positive or negative) of the magnitude change of the transformed input data observed at the time at which the event occurred. Only the sign of the event data (e.g., positive or negative depending on the direction of a magnitude change) is stored for the event data stored in the frequency domain bins of each row. Because each of the frequency domain bins in each row only stores event data indicative of a positive or negative event, the event data stored in the spectrotemporal event plane 206 can comprise a bit of information comprising one of three values (e.g., a “+” indicative of a positive event, a “−” indicative of a negative event, or a “1” or a “0” indicating the absence of an event). Therefore, in a configuration in which a single channel is used (e.g., first channel 206A) a large amount of information can be stored and represented by a small amount of data (i.e., a number representing positive, a number representing negative, or a number indicating no event occurred), thereby efficiently utilizing computer, storage, and processing resources, as well as decreasing latency and increasing processing speed for the analysis.

Furthermore, the values of the event data do not need to represent positive or negative magnitude changes. Alternatively, the event data values can be used to indicate other characteristics of the event data. For example, a first value can be stored as event data to represent an event in which the transformed input data is in a sine phase, and a second value can be stored as event data to represent an event in which the transformed input data is in a cosine phase. A third value can be used to indicate the presence of both sine and cosine phase events, and a fourth to indicate the absence of an event. Any other characteristics of the transformed input data can be represented, wherein each respective characteristic can be assigned any desired value, which values can then be stored as event data upon the occurrence of an associated event.

In a second example of the operation of the event-based SDC component 108, the spectrotemporal event plane 206 can include two or more planes or channels. In this configuration including multiple channels, the data storage of event data can be further simplified to storing only binary values (e.g., 0 or 1) to store and represent event data in the spectrotemporal event plane 206. For example, in the example above, only one grid (e.g., first channel 206A) is used for storing event data in the spectrotemporal event plane 206. However, event data storage can be further simplified by dividing the spectrotemporal plane into a plurality of channels (e.g., at least a first channel 206A and a second channel 206B). FIG. 2 illustrates that each of the first channel 206A and the second channel 206B can be represented by its own grid having K rows representing time and N columns representing frequency domain bins output by the FFT algorithm 202. As shown in FIG. 2, the first and second channels of the spectrotemporal event plane 206 can each store event data wherein each of the plurality of channels store event data having certain common features. For example, a first channel 206A of the spectrotemporal event plane 206 can be designated in the system to store positive event data (i.e., event data representing a positive threshold change in magnitude of the transformed input data) and a second channel 206B of the spectrotemporal event plane 206 can be designated in the system to store negative event data (i.e., event data representing a negative threshold change in magnitude).

Therefore, with the positive and negative event data being stored in different channels of the event plane, the sign of the event data is implicit based on the channel or grid in which the event data is stored. Rather than needing to store a first value for positive event data, a second value for negative event data, and a third value for no event data, the spectrotemporal event plane 206 having two channels can store positive data in the first channel 206A, such as by storing either a “1” for positive event data or a “0” for no event data. Negative event data can likewise be stored in the second channel 206B using either a “1” for negative event data or a “0” for no event data. In other words, the event data can be characterized and stored using only two values instead of three when using multiple channels in the spectrotemporal event plane 206. Therefore, utilizing two or more channels in the spectrotemporal event plane 206 can further improve computer functioning by storing and representing event data using bits of information (i.e., a number representing occurrence of an event and a number representing that no event occurred), thereby even more efficiently utilizing computer, storage, and processing resources, as well as decreasing latency and increasing processing speed for the analysis.

In an alternative example, the event data can comprise phase/quadrature components such that event data associated with an event in which the transformed input data exists in a cosine phase is stored in the first channel 206A and event data associated with an event in which the transformed input data exists in a sine phase is stored in the second channel 206B. Therefore, rather than needing to store a first value for sine phase-based event data, a second value for cosine phase-based event data, a third value for both since and cosine data, and a fourth value for no event data, the spectrotemporal event plane 206 can store cosine phase-based event data in the first channel 206A using either a “1” for cosine phase-based event data or a “0” for no event data. Sine phase-based event data can likewise be stored in the second channel 206B using either a “1” for sine phase-based event data or a “0” for no event data. In other words, the event data can be characterized and stored using only two values (e.g., a single bit) instead of four values (e.g., two bits) when using multiple channels in the spectrotemporal event plane 206. The event data stored in the spectrotemporal event plane 206 can be stored in each of the separate channels (e.g., 206A and 206B) operating in parallel as the data is output from the event detector array 204.

As an alternative example, the spectrotemporal event plane 206 is not limited to just two channels, but can include any number (N) of channels 206N for channelizing and storing event data of specified characteristics. For example, the channels 206A-206N can include a first channel 206A that stores event data having positive sine magnitude changes, a second channel 206B that stores event data having positive cosine magnitude changes, a third channel 206C that stores event data having negative sine magnitude changes, and a fourth channel 206D that stores event data having negative cosine magnitude changes. Because each channel 206A-206D is represented by its own grid with all channels operating in parallel, the positive, negative, cosine, and sine phase-based event data can be stored in different channels. Therefore, the sign of the event data is implicit based on the grid it occupies. As such, the positive, negative, sine, or cosine phase-based values of the event data need not be stored in the grid (e.g., channels 206A-206N). Instead, the mere existence of an event can be indicated by simple binary values. For example, a “1” (e.g., a single bit) can be stored in the proper row and column of the grid of its respective channel to represent the presence of event data. All other values of the event data (e.g., frequency, time, positive, negative, cosine, sine) are implied by the position (e.g., row, column, channel) of the stored bit in the spectrotemporal event plane 206. Vacancies in the spectrotemporal event plane 206 where no event data occurs can be populated with a “0”.

Each of the multiple channels 206A-206N can be designated to represent any characteristic of the transformed input data desired to be monitored by a user or software program. For example, the first channel 206A can be designated to represent sine phase-based event data, the second channel 206B can be designated to represent cosine phase-based event data, a third channel 206C can be designated to represent positive change event data, and a fourth channel 206D can be designated to represent negative change event data. In other words, the data that each channel is designated to store and represent is not intended to be particularly limited by this disclosure, but can instead be determined and selected by a user, software program, or others.

Following an analysis interval in which the input data is transformed by the FFT algorithm 202 and each of the N channels are populated with event data in their current (e.g., topmost) row, the event data stored in the grids for all channels (whether a single channel 206A or multiple channels 206A-206N) can be output to a saliency-classifier Convolutional Neural Network (CNN) 208 programmed to, for example, analyze imagery, signals, or data to detect salient features in the event data. The saliency-classifier CNN can operate on the entire event plane or any combination of sub-regions (subsets of rows and columns) or individual channels 206A-206N, either by construction or under control given prior to or during system operation.

In one implementation, prior to outputting the event data from the event plane to the saliency-classifier CNN 208, all event data stored in each channel 206A-206N in the spectrotemporal plane 206 shifts down by one row. For example, the event data of the uppermost row is moved down to a row immediately below the uppermost row, event data in the second row from the top is moved down to a third row from the top, and so on. The bottommost rows from all the channels 206A-206N, which contain any events from an oldest analysis interval stored in the event plane can be discarded and the uppermost rows of the grids in each channel 206A-206N become vacant in anticipation of new events from the most recent analysis interval carried out by the FFT algorithm 202 and the event detector array 204.

For example, when transformation of the input data is performed at a first analysis interval and event data is generated for the first analysis interval, first event data corresponding to the first analysis interval is stored in a first row of the one or more rows of the event plane or channel. For a second analysis interval subsequent to the first analysis interval, the first event data is moved to a second row of the event plane below the first row and second event data corresponding to the second analysis interval is stored in the first row of the event plane. For an event plane including, for example, 10 rows, the process of populating each row continues and reaches a point where the first event data from the first analysis interval is in an end or bottommost row of the event plane, second event data is in the penultimate row, and so on until reaching the topmost row containing the event data from a tenth analysis interval. At this point, upon execution of an eleventh analysis interval subsequent to the tenth analysis interval, the first event data is dropped, removed, and/or bumped from the event plane and the other instances of event data are also moved down a row in the event plane such that the event data from the eleventh analysis interval is stored in the first row of the event plane. As stated elsewhere, the event plane can comprise any number of rows K for storing successive packets of event data over each analysis interval. The number of rows K can be a configurable parameter corresponding to the duration over which the received signal is to be analyzed by event-based SDC component.

The saliency-classifier CNN 208 can be programmed to detect certain data within the event data that may be salient, or in other words relevant or significant, to certain features being sought after in an input signal. The features deemed salient in event data can be set by a user, can be predetermined default features stored in the CNN, or can be automatically detected by the CNN. The saliency-classifier CNN 208 classifies the event data from the spectrotemporal event plane 206 as either salient or non-salient. The saliency-classifier CNN 208, after classifying event data as salient data or non-salient data, can output the salient data to the downstream processor 110 (e.g., a run-time reconfigurable array (RTRA)) for further processing.

The downstream processor 110 can be programmed to analyze and process the salient data according to desired algorithms or instructions and then output the result as analysis output data 112. It is to be understood that the downstream processor 110 can represent any downstream analysis stage and is not intended to be limited to a single downstream processor. The downstream processor 110 can represent analysis of data for any purpose. For example, the downstream processor can represent analysis of data for converting and presenting the salient data in a visual or graphical format to a human operator to indicate any activity or feature of interest in the input signal. For example, the signal can be analyzed for the presence of event data indicating the presence of birds, marine animals, or other biological sounds or radiation that can be identified in a signal. The data can alternatively be analyzed for indications such as vibration signatures associated with imminent machinery component failure, or gear or bearing damage. The analysis output data 112 can be used by the user, additional algorithms, computers, processors, and/or programs for any desired application or function without any intended limitation.

The salient data output from the event-based SDC component 108 and the analysis output data 112 from the downstream processor 110 can be supplied to update the decision logic 104. The decision logic 104 can be updated by altering any of the initial processing parameters 106 based on the salient data and/or analysis output data 112. For example, if the salient data or analysis output data indicate that salient data is mostly or completely found in certain frequency ranges that are smaller than the initial band selection, then the band selection initial processing parameter may be reduced to focus on more particular bands in which salient data is likely to be found. The predetermined threshold value may be increased or decreased depending on whether the salient data or analysis output data indicate that the predetermined threshold value was set too large or too small to obtain necessary or useful data. If analysis of a signal at a certain temporal resolution reveals features indicating known issues in either the salient data or the analysis output data, then the temporal resolution of the decision logic 104 can be altered to another temporal resolution associated with confirming such issues. For example, in analyzing vibration signals in machinery, a low-resolution analysis of the input signal may reveal a broadband signature that suggests a problem with a bearing or other mechanical element. The decision logic 104 can then reconfigure the analysis to zoom in or/out on a narrower/broader spectral band and at a higher/lower temporal resolution to determine which mechanical elements are problematic.

In short, any of the initial processing parameters (e.g., temporal resolution, analysis interval, analysis window, number of FFT bins, predetermined threshold value, sampling rate, and/or band selection) can be updated to better analyze an input signal based on previously obtained data and to better hone in on data of interest in subsequent analyses. The analysis output data 112, whether used to update the decision logic or not, can be printed, displayed, or output in any suitable format for review by a user, device, system, or other computer algorithm.

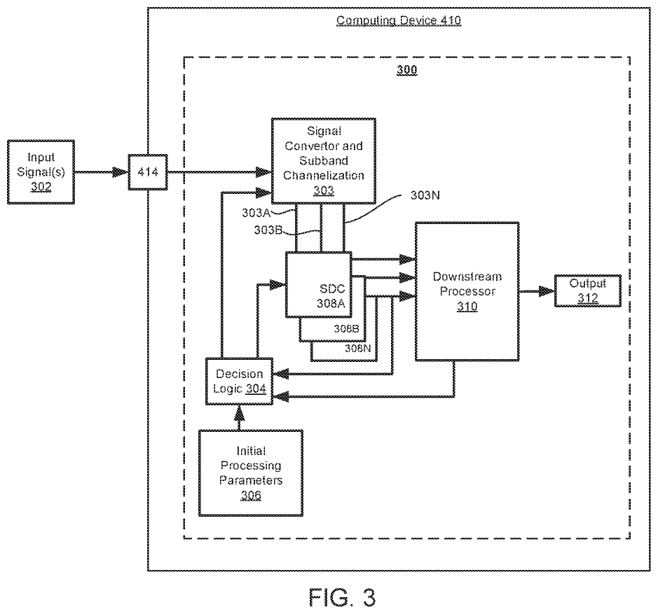

Alternative configurations of the system are contemplated within the scope of this disclosure. FIG. 3 illustrates an event-based signal classification system 300, such as for event-based Saliency Detection and Classification (SDC) of signals, signal feature extraction, and/or signal classification, with the following discussion focusing on event-based Saliency Detection and Classification (SDC) as an example. Similar to the system 100 shown in FIG. 1, FIG. 3 illustrates an input signal 302 (e.g., RF signals) that can be input into the system 300 via an input port 414 of a computing system 410 having one or more processors and one or more memory devices operable to store instructions executed by the at least one processor to carry out the functions and operations of the elements and components (i.e., elements 304-312) of the system 300. Similar to input signal 102, the input signal 302 can be any wave-based signals, such as temporal signals, spectrotemporal signals, temporal wavelet signals, electromagnetic waves/radiation, sound waves, multi-dimensional waves, and or other frequency or wave-based signals in either the frequency or wavelet domains without any intended limitation. The input signal 302 can include a plurality of frequencies or frequency bands. The input signal 302 can be input into system 300 using any signal input port 414 capable of interfacing with a computer similar to as described above with respect to system 100.

Although the system 300 is similar in many respects to the system 100 of FIG. 1, unlike the system 100, the system 300 can include a signal converter and subband channelization component 303. The signal converter and subband channelization component 303 can convert the input signal to input data that is readable by a computer, such as the computing device 410. The signal converter 303 can convert certain frequencies or frequency bands of the input signal to input data based on a band selection parameter defined by initial processing parameters 106 and/or decision logic 104. The signal converter 303 can further channelize the different frequencies and bands to different SDC components (e.g., 308A, 308B, 308N of FIG. 3 etc.) based on the decision logic 304. The decision logic 304 can include one or more initial processing parameters 306, including event-based criteria, that can define features of interest when processing the input data based on the input signal 302 and dictate how the input data is processed by the system 300. For example, the input signal 302 can include a plurality of frequencies and/or frequency bands. An initial processing parameter 306 can be a “band selection” that defines one or more frequencies or frequency bands of the input signal to analyze. Similar to the other processing parameters a user can define the band selection through user input to the system 300 via a user interface (e.g., one of the input devices 414 shown in FIG. 4). Alternatively, or additionally, the processing parameters can be preset to default values or automatically detected by the system 300 based on the type, frequency, or amplitude of the input signals 302, or based on other characteristics of interest initially stored in and/or detected by the system 300.

The input signal can be converted to input data by the signal converter and subband channelization component 303 and can further be separated into the selected frequencies or frequency bands defined by the band selection of the initial processing parameters 306 and decision logic 304. The selected bands and/or frequencies can be channelized into channelized data by the signal converter and subband channelization component 303 into separate channels, such as channels 303A, 303B, and 303N, based on the initial processing parameters 306 and decision logic 304. However, this is not intended to be limiting in any way as the selected bands and/or frequencies can be channelized into channelized data by the signal converter and subband channelization component 303 into any N number of channels, shown as Nth channel 303N. The channelized data separated into the channels 303A-303N can be input to a separate instance of event-based SDC components 308A, 308B, and 308N. Each of the event-based SDC components 308A-308N can have the same configuration as event-based SDC component 108 described above with respect to FIG. 2 and can process their respective channelized data in a manner similar to the event-based SDC component 108. Each of the event-based SDC components 308A-308N can include any number of channels (e.g., channels 206A-206N) as is necessary or desired for purposes of the user. By this configuration, multiple frequencies, frequency bands, and input signals in a dense and complex wave environment can be isolated and processed in parallel to other frequencies, bands, and/or signals. This modification can allow for processing of multiple frequency bands in parallel and can expand the complexity of input signals that are able to be analyzed by the system 300.

Multiple frequency bands can be transformed and processed for event detection and saliency classification at one time by the separate event-based SDC components 308A, 308B, and 308N. Salient data from each of the separate event-based SDC components 308A, 308B, and 308N can then be output to a downstream processor 310 that is programmed to analyze and process the salient data according to desired algorithms or instructions and then output the analysis result as analysis output data 312 for use by the user, additional algorithms, computers, processors, and/or programs for a desired application in a manner similar as described above. The salient data output from the event-based SDC components 308A, 308B, and 308N and the output data 312 from the downstream processor 310 can be supplied to update the decision logic 304 in a manner also similar as described above.

The total number of Saliency Detection and Classification Component Instances 308A-308N implemented depends on how many can be supported by the systems 300 size, weight, and power (SWaP) constraints, and also by the processing throughput required to achieve the desired signal analyses. The compute density of (or, in other words, the amount of information that can be processed per unit volume or mass by) the systems 100 and 300 can be context-dependent and can be optimized by selection and alteration of the processing parameters (e.g., band selection, number of bins, temporal resolution, sampling rate, analysis interval, analysis window, predetermined threshold value). A peak compute density of the systems 100 and 300 can be determined by a processing rate that can be supported by available power and cooling for the systems 100 and 300. Additionally, the computational throughput can scale upward as the number of Saliency Detection and Classification Component Instances 308A-308N is increased.

The systems 100 and 300 described above can exhibit several advantages and benefits for analysis of input signals and waves. For example, the event detection (e.g., that is carried out by the event detection array 204) can act to reduce the amount of data that needs to be stored (e.g., in a storage medium such as the spectrotemporal event plane 206) and processed (e.g., by the saliency classifier CNN). Without the benefit of event detection of the current disclosure, a typical prior input signal analysis system would need to store all input data based on an input signal (e.g., signal 102) that is input to a system. However, given that there may be large areas of the input signal that do not exhibit significant changes compared to other areas of the input signal, at least some of the computer storage and processing resources that are part of the prior input signal analysis system are wasted as they are caused to store and analyze similar data repeatedly without providing any additional useful information to a user. Accordingly, the analyses will take longer to run, increase latency, and will inefficiently use available computer resources without providing additional useful information to a user as compared to the systems described herein that utilize event-based detection, classification and analysis.

Indeed, with respect to the current system 100 of FIGS. 1 and 2, this system stores only “event data” (i.e., transformed input data that satisfies an event-based criterion) associated with “events” in which the magnitude of the transformed input data changes by an amount equal to or exceeding a predetermined threshold value. Therefore, data that does not show qualifying changes in magnitude need not be stored in the spectrotemporal event plane 206, need not be output to the saliency classifier CNN 208, and need not be analyzed by the downstream processor 110. Accordingly, storage is only used for certain data that may be relevant to further analysis and no storage in the spectrotemporal event plane 206 is used for irrelevant or unhelpful data (i.e., data that is not associated with an event, or non-event data). Furthermore, the saliency classifier CNN 208 does not waste valuable computer resources processing and classifying irrelevant data as non-salient or salient. Likewise, the downstream processor 110 does not unnecessarily consume processing resources by processing unhelpful data. Accordingly, the system, method, and devices described herein operate to improve the overall performance, efficiency, and functioning of a computer to provide faster and more efficient processing of input signals, such as RF signals.

The operations and components of systems 100 and 300 can be carried out and/or executed by a general-purpose computer or computing device. The operations can be carried out by a processor executing instructions stored on a memory device or non-transitory machine-readable storage medium. FIG. 4 illustrates such a computing device 410 on which modules of this technology may be executed. The computing device 410 is shown at a high-level and may be used as a controller to provide functionality to the systems 100 and/or 300 recited herein. The computing device 410 may include one or more processors 412 that are in communication with one or more memory devices 420. The computing device 410 may include a local communication interface 418 for the components in the computing device. For example, the local communication interface 418 may be a local data bus and/or any related address or control busses as may be desired.

The memory device 420 may contain modules 424 that are executable by the processor(s) 412 and data for the modules 424. In one example, the memory device 420 can contain a signal converter module (e.g., 103 of the system 100 shown in FIGS. 1 and 2), a signal converter and subband channelization module (e.g., 303 of the system 300 shown in FIG. 3), an event-based saliency detection and classification (SDC) module (e.g., 108 of the system 100 shown in FIGS. 1 and 2, or 308A-308N of the system 300 shown in FIG. 3), a decision logic module (e.g., 104 of the system 100 shown in FIGS. 1 and 2), a transform algorithm module (e.g., 202 of system 100 shown in FIGS. 1 and 2), an event detector array module (e.g., 204 of system 100 shown in FIGS. 1 and 2), an spectrotemporal event plane module or storage medium (e.g., 206 with channels 206A-206N of the system 100 shown in FIGS. 1 and 2), a saliency CNN module (e.g., 208 of the system 100 shown in FIGS. 1 and 2), and other modules. The modules 424 may execute the functions described earlier. A data store 422 may also be located in the memory device 420 for storing data related to the modules 424 and other applications along with an operating system that is executable by the processor(s) 412.

Other applications may also be stored in the memory device 420 and may be executable by the processor(s) 412. Components or modules discussed in this description that may be implemented in the form of software using high-level programming languages that are compiled, interpreted or executed using a hybrid of the methods.

The computing device 410 may also have access to I/O (input/output) devices 414 that are usable by the computing device 410, such as the input ports 414 described above with respect to the systems 100 and 300. In one example, the computing device 410 may have access to a display 430 to allow output of system notifications. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor(s) 412. The term “executable” may mean a program file that is in a form that may be executed by a processor 412. For example, a program in a higher-level language may be compiled into machine code in a format that may be loaded into a random-access portion of the memory device 420 and executed by the processor 412, or source code may be loaded by another executable program and interpreted to generate instructions in a random-access portion of the memory to be executed by a processor. The executable program may be stored in any portion or component of the memory device 420. For example, the memory device 420 may be random access memory (RAM), read only memory (ROM), flash memory, a solid-state drive, memory card, a hard drive, optical disk, floppy disk, magnetic tape, or any other memory components.

The processor 412 may represent multiple processors and the memory device 420 may represent multiple memory units that operate in parallel to the processing circuits. This may provide parallel processing channels for the processes and data in the system. The local communication interface 418 may be used as a network to facilitate communication between any of the multiple processors and multiple memories. The local communication interface 418 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine-readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

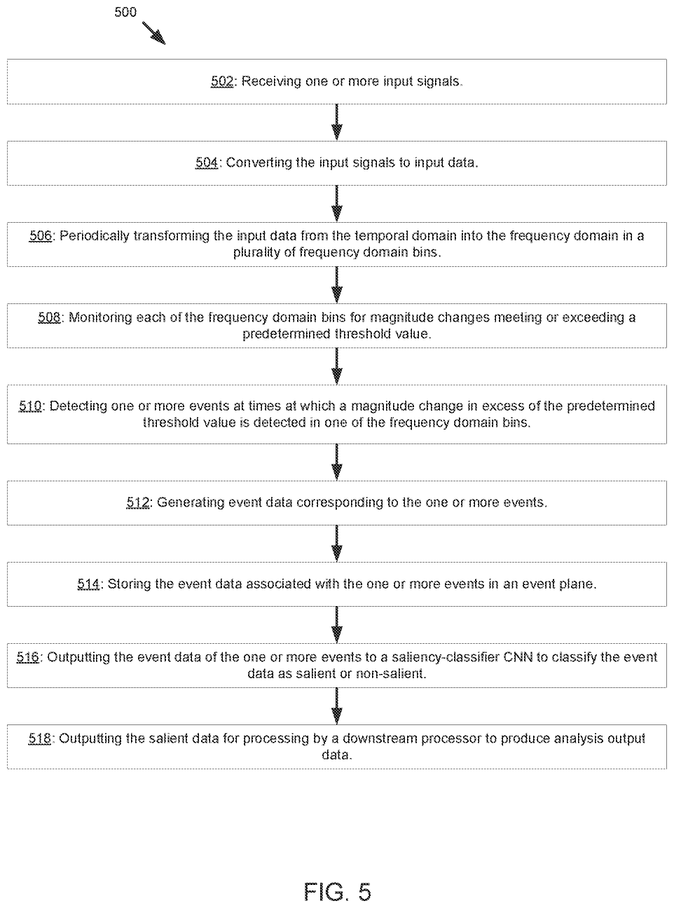

FIG. 5 illustrates a flow diagram showing the method 500 of operation carried out by the systems, devices, algorithms, and/or programs described herein. An exemplary process 600 of monitoring frequency domain bins for magnitude changes (e.g., steps 508, 510, and 512 of method 500) meeting or exceeding a predetermined threshold value is illustrated in FIG. 6A. The method 500 and process 600 sets forth the operational steps performed by the systems 100 and 300 discussed above. As such, an understanding of the method 500 and the process 600 can be had with reference to the steps described below, as well as the discussion above pertaining to the system 100 of FIGS. 1 and 2 and the system 300 of FIG. 3. The method 500 can be implemented by a computer including a memory and a processor that executes instructions stored on the memory. As illustrated, the method 500 can include a step 502 of receiving one or more input signals. The method 500 can further include a step 504 of converting the input signals to input data. The method 500 can further include a step 506 of periodically transforming the input data from the temporal domain into the frequency domain in a plurality of frequency domain bins. The method 500 can further include a step 508 of monitoring each of the frequency domain bins for magnitude changes that meet or exceed a predetermined threshold value. The method 500 can further include a step 510 of detecting one or more events at times at which a magnitude change meets or exceeds the predetermined threshold value is detected in one of the frequency domain bins. The method 500 can further include a step 512 generating event data corresponding to the one or more events. The method 500 can further include a step 514 of storing the event data associated with the one or more events in a spectrotemporal event plane. The method 500 can further include a step 516 of outputting the event data of the one or more events to a saliency-classifier CNN to classify the event data as salient or non-salient. The method can further include a step 518 of outputting the salient data for processing by a downstream processor to produce analysis output data.

As indicated above, an exemplary process 600 of monitoring frequency domain bins for magnitude changes in the transformed input data (e.g., steps 508, 510, 512, and 514 of method 500) meeting or exceeding a predetermined threshold value is illustrated in FIG. 6A. As illustrated, the monitoring process 600 starts at step 602. As shown in process 604, the monitoring process 600 can operate for an index value (i) ranging from 1 to N. For the range of the index value (i) from 1 to N, the process 604 obtains from each frequency domain bin (e.g., binᵢ=1 through N) an initial magnitude value (xᵢ). Then at process 606, the monitoring process 600 sets the index value at (i)=1. At process 608, the monitoring process 600 can then obtain a current magnitude value (yᵢ) at a current point in time from a current frequency domain bin (e.g., frequency domain bin).

The event detector array (e.g., 204) can then detect an “event” in the transformed input data of the frequency domain bin at decision 610 by comparing an initial magnitude (xᵢ) of the frequency domain binᵢ to a current magnitude (yᵢ) of the frequency domain binᵢ. This can be done by calculating a result of (yᵢ−xᵢ) and determining if the absolute value of (yᵢ−xᵢ) is greater than or equal to a predetermined threshold value (z).

When the current magnitude (yᵢ) does not represent a magnitude change meeting or exceeding the predetermined threshold value compared to the initial magnitude (xᵢ), (i.e., “No” of decision 610), the event detector array increases i to i+1 in process 612. The monitoring process 600 then continues to decision 614 in which it is determined if (i) is greater than N. If (i) is not greater than N, (i.e., “No” of decision 614), then the monitoring process 600 returns to process 608 and continues monitoring magnitude values by obtaining a new current magnitude value (yᵢ) from a new frequency domain binᵢ based on the new value of (i), which was previously indexed upward in process 612. The monitoring process then continues running through the processes and decisions 610, 615, 616, 618, 612, and 614 of the monitoring process 600. Alternatively, if at process 614 it is determined that (i) is greater than N, then the process 600 continues to process 606 at which time (i) is set back to 1 and the subsequent processes and steps (e.g., one or more of 608, 610, 612, 614, 615, 616, and 618) can be executed for each frequency domain binᵢ for another point in time following the point in time of the previous analysis.

Now, with returning reference to decision 610, in a case in which the absolute value of (yᵢ−xᵢ) is greater than or equal to a predetermined threshold value (z), (i.e., “yes” in decision 610), then the event detector array detects an event indicating a magnitude change meeting or exceeding the threshold value in process 614. The process then, in process 615, generates event data indicating the magnitude change and the time at which the magnitude change occurred as a result of detecting the event. The event data is then stored in the spectrotemporal event plane (e.g., 206) as an event (i.e., initial event) in process 616. Subsequently, in process 618, the initial magnitude value (xᵢ) can be changed such that (xᵢ)=(yᵢ). In other words, in subsequent iterations of process 600, the current magnitude values (e.g., (yᵢ₊₁)) are compared to previous magnitude values (i.e., (yᵢ)) at which an event was observed instead of comparing current magnitude values (e.g., (yᵢ₊ᵢ)) to the initial magnitude value (xᵢ).

Following process 618, the event detector array increases i to i+1 in process 612. The monitoring process 600 then continues to decision 614 in which it is determined if (i) is greater than N. If (i) is not greater than N, (i.e., “No” of decision 614), then the monitoring process 600 returns to process 608 and continues monitoring magnitude values by obtaining a new current magnitude value (yᵢ) from a new frequency domain binᵢ based on the new value of (i), which was previously indexed upward in process 612. The monitoring process then continues running through the processes and decisions 610, 615, 616, 618, 612, and 614 of the monitoring process 600. Alternatively, if at process 614 it is determined that (i) is greater than N, then the process 600 continues to process 606 at which time (i) is set back to 1 and the subsequent processes and steps (e.g., one or more of 608, 610, 612, 614, 615, 616, and 618) can be executed for each frequency domain binᵢ for another point in time following the point in time of the previous analysis.

As described above, the monitoring process 600 can go through N number of frequency domain bins (e.g., binᵢ from 1 to N for index value i) designated by the fast Fourier transform algorithm (e.g., FFT 202). Each of the frequency domain binsᵢ represents a range of frequencies (e.g., 100 Hz to 110 Hz for a case in which each frequency domain binᵢ covers a range of 10 Hz) of the input signal in the frequency domain. For the range of frequencies represented by each frequency domain binᵢ, a magnitude of the input signal and a time at which the magnitude occurred is represented. The associated time at which the magnitude occurred is implicitly represented by the analysis rate and system starting time, and subsequently by any corresponding event's location in the event plane.

According to the illustrated process 600, the event detector array 204 monitors the magnitude of the transformed input data through each frequency increment of each frequency domain binᵢ. For example, if a certain frequency domain binᵢ covers a range from 100 Hz to 110 Hz and includes data for each 1 Hz increment, then the initial magnitude (xᵢ) can occur at 100 Hz and the (yᵢ) magnitude can occur at 101 Hz. The magnitudes can proceed as being a magnitude at 102 Hz, another magnitude at 103 Hz, and so on until the last magnitude for the frequency domain binᵢ occurs at 110 Hz.

While the process 600 illustrates that each frequency domain bin is processed in parallel with each other, it is to be understood that each frequency domain bin can be processed separately from each other such that the processing of one bin is completed before another bin is analyzed. In other words, it is to be understood that the multiple frequency domain bins can be monitored and processed at the same time in parallel with each other or separately from each other without departing from the scope of the disclosure. The domain bins are not intended to be limited to only being analyzed in sequence.

Additionally, alternative or additional steps can be added to the process 600 in order to improve the monitoring process 600. For example, as illustrated in FIG. 6B, an additional process 620 can be added for the purpose of updating the initial magnitude (xᵢ) to gradually vary in order to track with minor movements or changes in the current magnitude value (yᵢ). This serves a purpose of filtering out small changes between the current magnitude value (yᵢ) and the initial magnitude value (xᵢ), which small changes by themselves do not exceed the threshold value (z), but over an amount of time can cause the current magnitude values (yᵢ through y_{i+N}) that are obtained to gradually drift away from the initial magnitude value (xᵢ). By the small changes to current magnitude values over time, a very small change in the current magnitude value can cause the difference between one of the current magnitude values (yᵢ through y_{i+N}) and the initial magnitude value (xᵢ) to exceed the threshold (z) and trigger an event, when, in fact, no change big enough to worth noting as an event occurred. For purposes of this disclosure, large changes in magnitude over short periods of time may signify a feature of interest in an input signal while smaller changes over longer periods of time may not signify any features of interest in the input signal. Accordingly, it can be advantageous to disregard small changes over long periods of time that may together trigger a magnitude change greater than or equal to the threshold value (z).

To prevent small gradual changes in magnitude from triggering an event, in process 620, (xᵢ) can be modified by an equation that allows the initial value (xᵢ) to track along with minor changes in the current values (yᵢ). For example, process 600B can, in process 610, monitor each of the frequency domain bins for magnitude changes in the transformed input data (e.g., current magnitude value (yᵢ)) relative to an initial magnitude value (xᵢ) that are below the predetermined threshold value (z). In a case in which the magnitude change in the input data (yᵢ) relative to an initial magnitude value (xᵢ) does not exceed the threshold value (z) (i.e., “No” in process 610), the flow of process 600B can proceed to process 620.

In process 620 the initial magnitude value (xᵢ) can be updated to a new updated magnitude value that tracks magnitude changes in the transformed input data (yᵢ) that are below the predetermined threshold value (z). For modifying the initial magnitude value (xᵢ), an equation can be used to weight both (xᵢ) and (yᵢ) with a factor a. The sum of the weighted values of (xᵢ) and (yᵢ) can be used to change (xᵢ) such that (xᵢ) changes and tracks along with minor changes to (yᵢ) over a number of iterations of the process 600B. The factor a can be chosen by a user or by software to track (xᵢ) with (yᵢ) at a desired or calculated rate.

A sample equation can be setting xᵢ=αyᵢ+(1−α)xᵢ. The factor a can be some a where 0<α<1. As an example, if a is set to equal 0.1, then xᵢ can be modified as follows (xᵢ=0.1yᵢ+(0.9)xᵢ) such that the modified initial magnitude value xᵢ includes a large portion of the unmodified xi and a small portion of the current magnitude value yᵢ. The term a can be set to determine a rate and manner in which (xᵢ) tracks with changes in (yᵢ). Thus, the equation modifies the initial magnitude value xᵢ with a portion of the current magnitude value (yᵢ) to ensure that the initial magnitude value (xᵢ) tracks along with changes to the current magnitude value (yᵢ) in iterations of the process 600B in which a magnitude changes (e.g., absolute value of (yᵢ−xᵢ) is not greater than or equal to a predetermined threshold value (z), (i.e., “no” in decision 610)).

While this is one sample equation that can be used to have (xᵢ) track with (yᵢ), it is to be understood that other equations may similarly be used to track (xᵢ) with (yᵢ). Modifying (xᵢ) in this manner advantageously updates the initial magnitude value (xᵢ) to slowly track the current magnitude value (yᵢ) over time, so that small magnitude changes (i.e. magnitude changes occurring little by little over many analysis intervals) between the initial magnitude (xᵢ) and current magnitude (yᵢ) that do not meet or exceed the threshold (z) do not accumulate over time and produce undesired events. Accordingly, as illustrated in FIG. 6B, process 610 can monitor each of the frequency domain bins for magnitude changes below the predetermined threshold value (z) and can update the initial magnitude value (xᵢ) to a modified magnitude value that tracks the transformed input data (e.g., current magnitude (yᵢ)) when a magnitude change that is below the predetermined threshold value is detected.

Following modification of the initial magnitude value (xᵢ) to the modified magnitude value, process 600B can then monitor each of the frequency domain bins for magnitude changes in the transformed input data relative to the updated magnitude value that meet or exceed the predetermined threshold value (e.g., process 610). The process 600B can then detect an event when a magnitude change meeting or exceeding the predetermined threshold value is monitored (e.g., “Yes” in process 610). The process 600B can then generate event data for the event (e.g., in process 615) and store the event data in the event plane (e.g., in process 616). The event data can then be output for further processing to produce analysis output data.

As illustrated in FIGS. 6A and 6B, the processes 600 and 600B can proceed indefinitely for an infinite amount of time without end as long as an input signal is being input (e.g., into system 100) for analysis. However, it will be understood that the process can be terminated at any time by a user. Additionally, the processes 600 and 600B can be set to run for a certain amount of analysis intervals, for a certain defined time period, or can be set to terminate at a point when i=N. The termination of the process can be triggered in any way without intended limitation.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. An event-based signal detection and classification system comprising:
a signal converter operable with an input, and operable to receive and convert one or more input signals;
at least one processor;
a memory device including instructions that, when executed by the at least one processor, cause the system to:
receive, via the input, an input signal of the one or more input signals;
convert the input signal to input data;
input the input data to an event-based detection and classification component;
transform, periodically, the input data from the temporal domain into transformed input data in the frequency domain in a plurality of frequency domain bins;
monitor each of the frequency domain bins for magnitude changes that meet or exceed a predetermined threshold value;
detect an event when a magnitude change meeting or exceeding a predetermined threshold value is monitored;
generate event data for the event, wherein the event data corresponds to a point in time at which a magnitude change that meets or exceeds the predetermined threshold value is detected in one of the frequency domain bins; and
output the event data for further processing to produce analysis output data.

2. The system of claim 1, wherein event data for each event is stored in an event plane comprising:
one or more rows each representing a point in time at which the event corresponding to the event data occurred; and
one or more columns each representing a frequency domain bin of the plurality of frequency domain bins.

3. The system of claim 2, wherein transforming the input data is performed at an analysis interval defining a rate at which the input data is processed by the event-based detection and classification component; and
wherein event data is generated for each analysis interval in which the input data is transformed;
wherein the event data corresponding to each analysis interval is stored in a row of the one or more rows of the event plane.

4. The system of claim 3, wherein first event data corresponding to a first analysis interval is stored in a first row of the event plane; and
wherein, for a second analysis interval subsequent to the first analysis interval, the first event data is moved to a second row of the event plane different than the first row, and second event data corresponding to the second analysis interval is stored in the first row of the event plane.

5. The system of claim 4, wherein, when the first event data corresponding to the first analysis interval is stored in a last row of the event plane, then upon execution of a third analysis interval subsequent to the first and second analysis intervals, third event data is stored in the first row of the event plane, the second event data is moved to another row of the event plane different then the first row, and the first event data is removed from the event plane.

6. The system of claim 1, wherein event data is stored in separate channels of the event plane based on differences in one or more characteristics of the event data, the separate channels comprising:
a first channel that stores event data representing positive magnitude changes; and
a second channel that stores event data representing negative magnitude changes.

7. The system of claim 1, wherein event data is stored in separate channels of the event plane based on differences in one or more characteristics of the event data, the separate channels comprising two or more of:
a first channel that stores event data representing positive sine magnitude changes;
a second channel that stores event data representing negative sine magnitude changes;
a third channel that stores event data representing positive cosine magnitude changes;
a fourth channel that stores event data representing negative cosine magnitude changes.

8. The system of claim 1, wherein the memory device further includes instructions that, when executed by the at least one processor, cause the system to designate one or more initial processing parameters including at least one of:
a band selection defining one or more frequency bands of the input signal to analyze;
a temporal resolution defining a predetermined time interval for sampling the input data;
an analysis interval defining a rate at which the input data is processed by the event-based detection and classification component; and
the predetermined threshold value defining the magnitude change value for detecting the event.

9. The system of claim 8, wherein the memory device further includes instructions that, when executed by the at least one processor, cause the system to:
alter the one or more initial processing parameters based on at least one of the analysis output data and the salient data.

10. The system of claim 1, wherein monitoring each of the frequency domain bins for magnitude changes that meet or exceed the predetermined threshold value comprises:
detecting a first magnitude in a first frequency domain bin; and
monitoring magnitudes in the first frequency domain bin subsequent to the first frequency domain bin for a second magnitude representing a magnitude change that meets or exceeds the predetermined threshold value compared to the first magnitude.

11. The system of claim 10, wherein the memory device further includes instructions that, when executed by the at least one processor, cause the system to:
monitor magnitudes in the first frequency domain bin subsequent to the second magnitude for a third magnitude representing a magnitude change that meets or exceeds the predetermined threshold value compared to the second magnitude.

12. The system of claim 1, wherein the memory device further includes instructions that, when executed by the at least one processor, cause the system to:
output the event data to a saliency-classifier Convolutional Neural Network (CNN) to classify the event data as salient data or non-salient data; and
output the salient data for processing by a downstream processor to produce the analysis output data.

13. The system of claim 1, wherein the memory device further includes instructions that, when executed by the at least one processor, cause the system to:
monitor each of the frequency domain bins for magnitude changes in the transformed input data relative to an initial magnitude value that are below the predetermined threshold value; and
update the initial magnitude value to an updated magnitude value that tracks magnitude changes in the transformed input data below the predetermined threshold value;
monitor each of the frequency domain bins for magnitude changes in the transformed input data relative to the updated magnitude value that meet or exceed the predetermined threshold value;
detect an event when a magnitude change meeting or exceeding the predetermined threshold value is monitored;
generate event data for the event, wherein the event data corresponds to a point in time at which a magnitude change that meets or exceeds the predetermined threshold value is detected in one of the frequency domain bins; and
output the event data for further processing to produce analysis output data.

14. The system of claim 1, wherein the frequency domain bins comprise at least one of wavelet transform bins, Fourier transform bins, discrete Fourier transform bins, or a non-uniform discrete Fourier transform bins.

15. A computer-implemented method comprising:
receiving, via an input, one or more input signals;
converting the one or more input signals to input data;
inputting the input data to an event-based detection and classification component;
transforming, periodically, the input data from the temporal domain into transformed input data in the frequency domain in a plurality of frequency domain bins;
monitoring each of the frequency domain bins for magnitude changes that meet or exceed a predetermined threshold value;
detecting an event when a magnitude change meeting or exceeding a predetermined threshold value is monitored;
generating event data for the event, wherein the event data corresponds to a point in time at which a magnitude change meets or exceeds the predetermined threshold value is detected in one of the frequency domain bins;
outputting the event data for further processing to produce analysis output data.

16. The method of claim 15, further comprising:
outputting the event data to a saliency-classifier Convolutional Neural Network (CNN) to classify the event data as salient data or non-salient data; and
outputting the salient data for processing by a downstream processor to produce the analysis output data.

17. The method of claim 15, further comprising:
designate one or more initial processing parameters including at least one of:
a band selection defining one or more frequency bands of the input signal to analyze;
a temporal resolution defining a predetermined time interval for sampling the input data;
an analysis interval defining a rate at which the input data is processed by the event-based detection and classification component; and
the predetermined threshold value defining the magnitude change value for generating the event.

18. The method of claim 15, further comprising:
storing the event data in separate channels of the event plane based on differences in one or more characteristics of the event data, the separate channels comprising:
a first channel that stores event data representing positive magnitude changes;
a second channel that stores event data representing negative magnitude changes.

19. The method of claim 15, wherein monitoring each of the frequency domain bins for magnitude changes that meet or exceeds the predetermined threshold value comprises:
detecting a first magnitude in a first frequency domain bin; and
monitoring magnitudes in the first frequency domain bin subsequent to the first frequency domain bin for a second magnitude representing a magnitude change that meets or exceeds the predetermined threshold value compared to the first magnitude.

20. The method of claim 19, wherein monitoring each of the frequency domain bins for magnitude changes that meet or exceed the predetermined threshold value further comprises:
monitoring magnitudes in the first frequency domain bin subsequent to the second magnitude for a third magnitude representing a magnitude change that meets or exceeds the predetermined threshold value compared to the second magnitude.

21. A non-transitory machine-readable storage medium including instructions embodied thereon, wherein the instructions, when executed by at least one processor:
receive, via the input, an input signal of the one or more input signals;
convert the input signal to input data;
input the input data to an event-based detection and classification component;
transform, periodically, the input data from the temporal domain into transformed input data in the frequency domain in a plurality of frequency domain bins;
monitor each of the frequency domain bins for magnitude changes that meet or exceed a predetermined threshold value;
detect an event when a magnitude change meeting or exceeding the predetermined threshold value is monitored;
generate event data for the event, wherein the event data corresponds to a point in time at which a magnitude change meets or exceeds the predetermined threshold value is detected in one of the frequency domain bins; and
output the event data for further processing to produce analysis output data.

22. The non-transitory machine-readable storage medium in claim 21, wherein the memory device further includes instructions that, when executed by the at least one processor, cause the system to:
output the event data to a saliency-classifier Convolutional Neural Network (CNN) to classify the event data as salient data or non-salient data; and
output the salient data for processing by a downstream processor to produce the analysis output data.
